(19) United States
(12) Patent Application Publication
(10) Pub. No.: US 2003/0215144 A1
(43) Pub. Date: Nov. 20, 2003

(54) Additional image extraction apparatus and method for extracting additional image

(75) Inventors: Eiichi Kito, Kanagawa (JP); Shinji Ito, Kanagawa (JP); Hiroaki Nakamura, Kanagawa (JP); Kazuyuki Tanaka, Kanagawa (JP); Tsuyoshi Ota, Tokyo (JP)

Correspondence Address: SUGHRUE MION, PLLC, 2100 PENNSYLVANIA AVENUE, N.W., WASHINGTON, DC, 20037, US

(73) Assignees: FUJI PHOTO FILM CO., LTD.; HITACHI SOFTWARE ENGINEERING CO., LTD.

(21) Appl. No.: 10/438,074

(22) Filed: May 15, 2003

(30) Foreign Application Priority Data
May 16, 2002 (JP) 2002-141981

(51) Int. Cl. G06K 9/46

(52) U.S. Cl. 382/190

(57) ABSTRACT

A synthetic image print system has an additional image extraction function for extracting additional images based on extraction criteria. An additional image extraction program, the data of each additional image, and an additional image feature information file listing features of each additional image are stored on storage. Of all additional images, the additional images with the feature information corresponding with the extraction criteria are extracted. The features of a photographed image, a search keyword inputted by a user, the user profile information and the like are used as the extraction criteria.

### BACKGROUND OF THE INVENTION

1. Field of the Invention

The present invention relates to an additional image extraction apparatus for extracting specific additional images on the basis of extraction criteria, when a user selects the additional image, which is synthesized with a photographed image.

2. Background Arts

Service of creating a synthetic image from a photographed image and an additional image for decorating the photographed image is generally known. In creating the synthetic image, an image brought in by a user or prepared by a vendor is used as the additional image. The vendor prepares various types of additional images, for the purpose of responding to various needs of the user. As the additional image, there are a decorative image, a letter string frame, a template image and the like. The decorative image has a pattern or a mark partially overlapping with the photographed image. The letter string frame has an arbitrary letter string overlapping with the photographed image. The template image has a fitting frame in which the photographed image is fitted. Various landscapes and patterns are used as the decorative image and the template image.

In receiving an order for the synthetic image, as disclosed in Japanese Patent Laid-Open Publication No. 2000-244724, for example, these many additional images are listed and displayed on a selection screen of an image synthesis apparatus. The four to eight additional images per page, for example, are displayed on the selection screen. Other additional images are sequentially displayed by operating a page down button, a scroll bar or the like. The user selects the desired additional image with repeating operation like this.

The types and the number of the additional images have more and more increased, as the capacity of storage for storing the additional images steeply increases due to technological advances. Accordingly, the selecting operation to find out the desired additional image from the enormous numbers of them is troublesome for the user, because it needs much expense in time and effort.

### SUMMARY OF THE INVENTION

An object of the present invention is to provide an additional image extraction apparatus and a method for extracting an additional image, in which expense in time and effort for selecting the additional image is reduced.

To achieve the above object, an additional image extraction apparatus according to the present invention comprises a memory device, a selection device, and a display device. The memory device stores the feature information, which expresses the features of plural additional images, in relation to each additional image. The selection device extracts the additional images having the feature information which corresponds with an extraction criterion. The display device displays the additional images extracted by the selection device.

The additional image extraction apparatus may be provided with an image analysis device for analyzing the feature of an input image. The feature of the input image is used as the extraction criterion.

The additional image extraction apparatus may be provided with an input device from which a user inputs an arbitrary search keyword. The search keyword is used as the extraction criterion.

The additional image extraction apparatus may be provided with profile information of the user, which is used as the extraction criterion.

The memory device counts a usage number of each additional image. The display device displays a plurality of the extracted additional images in order of declining the usage number.

The additional image extraction apparatus further comprises an agreement degree calculation device. The agreement degree calculation device calculates agreement degree between the feature information of the additional image and the extraction criterion. The display device displays a plurality of the extracted additional images in order of declining the agreement degree.

The additional image extraction apparatus further comprises a designation device for designating an arbitrary area within the input image. The selection device excludes the additional image which overlaps with the designated area, in order to prevent the area from being covered with the additional image.

The memory device stores advertisement images and synthetic requirement information in relation to each other. The selection device extracts the advertisement image related to the synthetic requirement information which corresponds with the user profile information, as the additional image.

The display device displays a discount rate of a synthetic charge. The synthetic charge is discounted at the discount rate when the advertisement image is synthesized with the input image.

The input image is a photographed image taken by a digital camera. Each of the photographed images has photograph information used as the extraction criterion.

According to the additional image extraction apparatus of the present invention, proper additional images are extracted from the plural additional images, on the basis of the feature information of the additional image and the extraction criterion. Therefore, it is possible for the user to efficiently select the additional image, without expense in time and effort.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a block diagram showing the electrical configuration of a synthetic image print system which is provided with an additional image extraction apparatus;

FIG. 2 is an explanatory view showing the data structure of a photographed image file stored on a memory card;

FIG. 3A is an explanatory view of an additional image;

FIG. 3B is an explanatory view of another additional image;

FIG. 4A is an explanatory view of further another additional image;

FIG. 4B is an explanatory view of further another additional image;

FIG. 5 is an explanatory view showing the contents of an additional feature information file;

FIG. 6 is an explanatory view showing the contents of a user information file;

FIG. 7 is an explanatory view of an inquiry screen on a display panel, which inquires whether to narrow a search or not;

FIG. 8 is an explanatory view of another inquiry screen on the display panel which inquires whether to input a search keyword or not;

FIG. 9 is an explanatory view of an additional image selection screen on the display panel;

FIG. 10 is an explanatory view of a photographed image on the display panel;

FIG. 11 is an explanatory view of a synthetic image on the display panel;

FIG. 12 is a flow chart showing the flow of selecting the additional image and creating a synthetic image;

FIG. 13 is a flow chart showing the flow of extracting the additional images;

FIG. 14 is a flow chart showing the flow of extracting the additional images to which agreement degree calculation processing is added;

FIG. 15 is an explanatory view of the photographed image on the display panel, when a no-synthetic area is designated;

FIG. 16 is an explanatory view of a synthetic image in which an advertisement image is synthesized;

FIG. 17 is a flow chart showing the flow of extracting the advertisement images;

FIG. 18 is an explanatory view of further another inquiry screen on the display panel, which inquires whether to synthesize the advertisement image or not;

FIG. 19 is an explanatory view of the selection screen of the advertisement images on the display panel;

FIG. 20A is an explanatory view showing the rear side of a membership card; and

FIG. 20B is an explanatory view showing the front side of the membership card.

### DETAILED DESCRIPTION OF THE EMBODIMENTS

A synthetic image print system 10 is installed in a photo shop, for example. The synthetic image print system 10 creates a synthetic image from a photographed image brought by a user and a selected additional image, and prints it. The synthetic image print system 10 has additional image extraction function for extracting the additional images which correspond with extraction criteria, so that a user can select the desired additional image from the extracted ones.

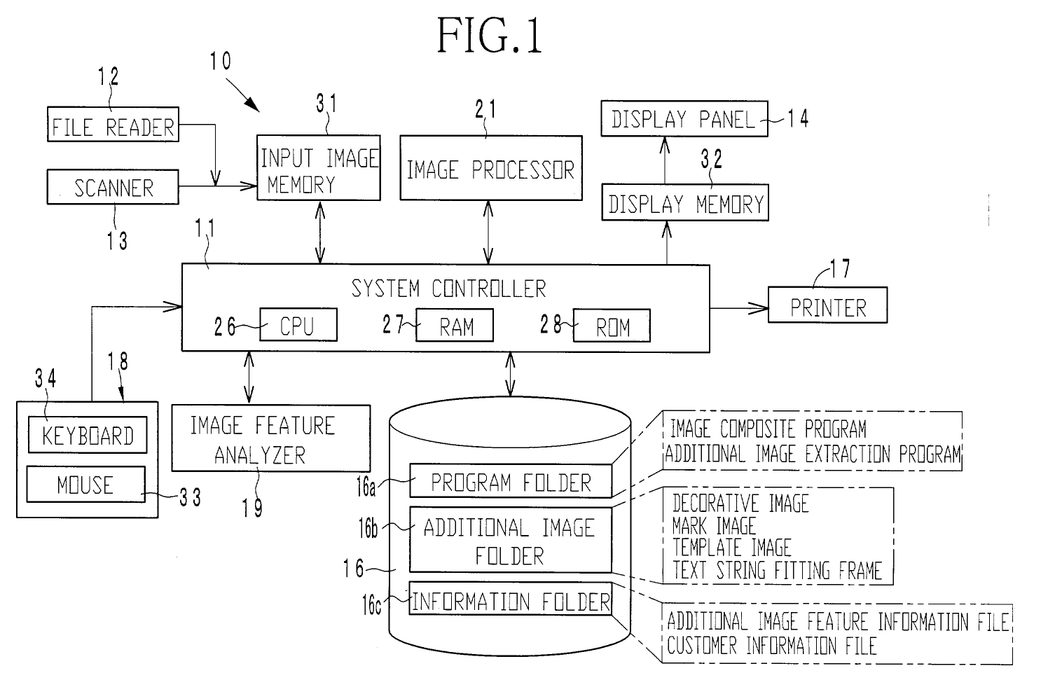

Referring to FIG. 1, the synthetic image print system 10 comprises a system controller 11, a file reader 12, a scanner 13, a display panel 14, storage 16, a printer 17, a command input device 18, an image feature analyzer 19, and an image processor 21. The system controller 11 including a CPU 26, a RAM 27, and a ROM 28 controls the operation of the synthetic image print system 10.

The file reader 12 is an image input device for capturing the photographed image on the synthetic image print system 10. The file reader 12 is provided with a memory card slot, for example, to read the image photographed with a digital camera from a memory card. A photographed image file is written into an input image memory 31.

A photo film scanner capturing the photographed image from a negative or positive photo film, a reflection copy scanner capturing the photographed image from the copy of a photo print, and the like may be used for capturing the image file. A drive for reading the photographed image from a recording medium such as a CD (Compact Disk), DVD (Digital Versatile Disk) or the like may be used as the film reader 12, besides a drive for the memory card.

Read photographed image, the selection screen of the additional image and the like are displayed on the display panel 14 via a display memory 32. The command input device 18 has a mouse 33 and a keyboard 34. The user operates the mouse 33 and the keyboard 34 to enter an operation command in the system controller 11, with looking at an operation screen displayed on the display panel 14.

The image processor 21 carries out various types of image processing such as image synthetic processing of the photographed image and the additional image, image corrective processing and the like. The printer 17 prints the photographed image or the synthetic image. The image feature analyzer 19 analyzes photographed image data, and extracts the features of the photographed image on the basis of information recorded on the photographed image file. The extracted feature information is used as the extraction criteria in extracting the additional images.

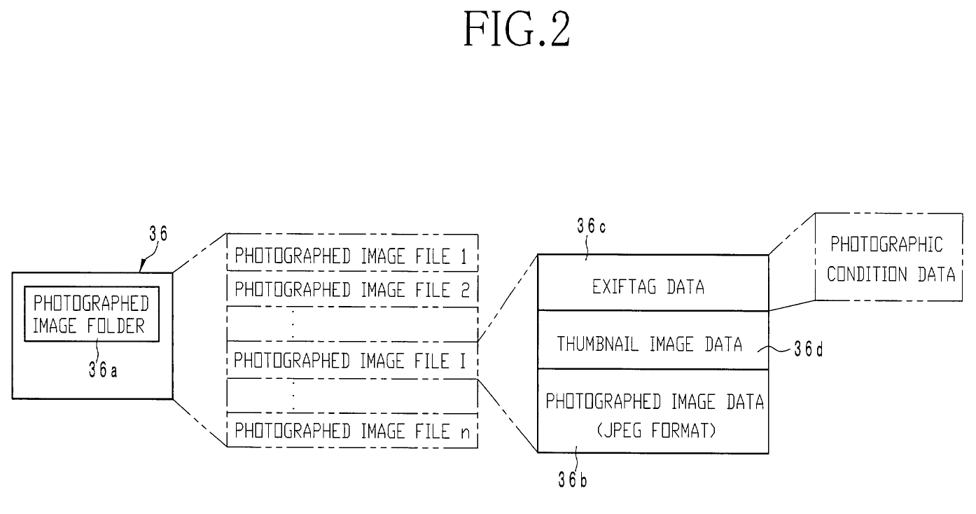

Referring to FIG. 2, a photographed image folder 36a is provided in a memory card 36 read on the file reader 12. The photographed image folder 36a contains plural photographed image files 1 ton, which are in an EXIF format, for example. The EXIF-format photographed image file includes photographed image data 36b compressed in JPEG format, and EXIFTAG data 36c. The photographed image file may include thumbnail image data 36d which is used for displaying an index.

The EXIFTAG data 36c includes photograph condition data concerning photograph conditions such as an exposure value, a focal length, the presence or absence of flash projection and the like, a photograph date, and the like. In a case where the digital camera has the function of writing a memorandum, a photographer can record a photographed time like a season and the time of day, a photographed occasion like a wedding ceremony, a party and a travel, a photographed location like the name of a country and the name of a sightseeing area and the like, on the EXIFTAG, with the use of this function. In a case where the digital camera has a GPS (Global Positioning System) function, photographed location information and the like are automatically recorded on the EXIFTAG.

The image feature analyzer 19 analyzes the photographed image data to find out main subject information (a person, a building, or scenery), tone information on the whole image, the distribution information of color, and the like. This analysis information and the additional information recorded on the EXIFTAG compose the feature information of the photographed image. The additional images are extracted based on the feature information.

On the basis of the tone information of the photographed image, for example, the additional images having a tone corresponding with the tone information are extracted. A season is estimated by the photograph date data, so that the additional images corresponding with the season are extracted. The additional images with an illustration of scenery, a building and the like near the photographed location are extracted on the basis of the photographed location information.

The additional image is used for creating the synthetic image with the photographed image. There are various types of additional images such as a decorative image with a pattern, a template image with a fitting frame for fitting the photographed image, a letter string frame for synthesizing an arbitrary letter string, and the like.

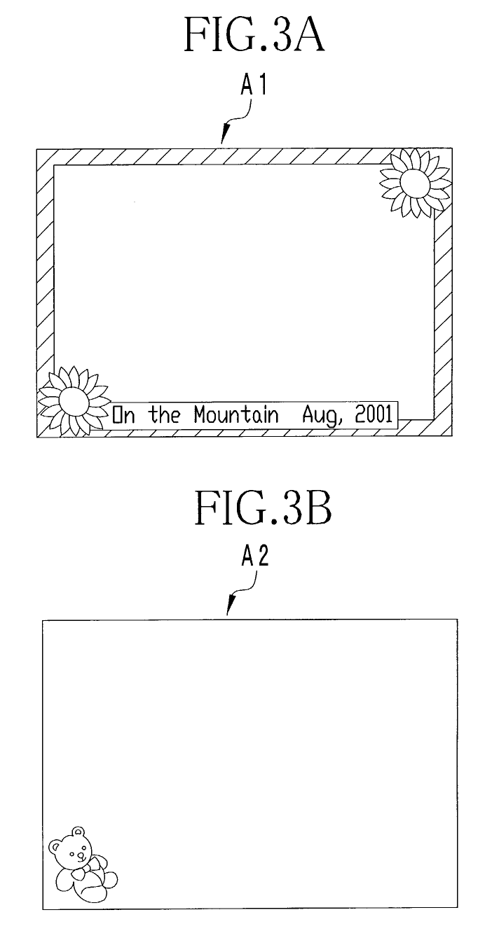

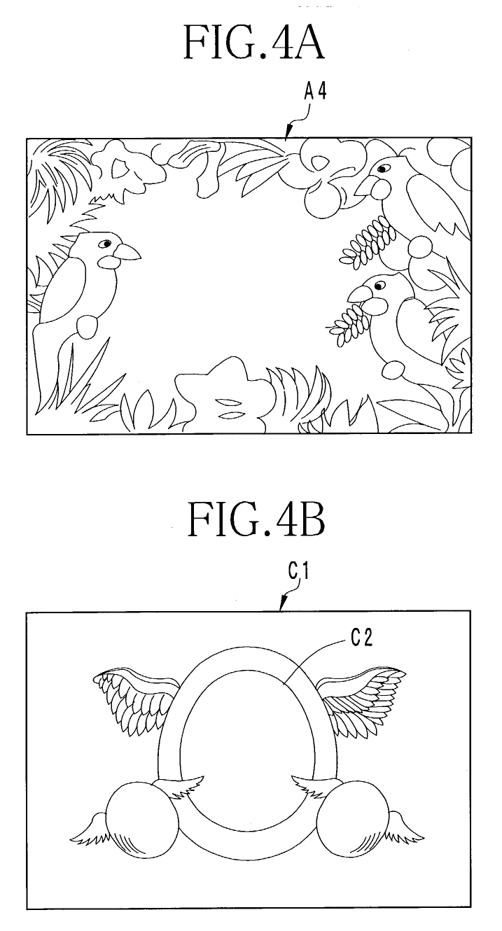

FIGS. 3A, 3B, 4A and 4B show embodiments of the additional images. An additional image A1 is the decorative image with a floral pattern. The additional image A1 is provided with a letter string frame for inputting the arbitrary letter string. It is possible to write a simple comment about the photographed image, like “On the Mountain August, 2001”, in the letter string frame.

An additional image A2 is the decorative image with an animal. An additional image A4 is the decorative image on which the jungle is illustrated. The additional images A1, A2 and A4 of plural sizes are prepared for the purpose of meeting the various sizes of the photographed images. The additional image of the proper size for the photographed image is synthesized with the photographed image. The position of the pattern like the animal and flower is fixed, so that a part of photographed image overlapping with the pattern disappears. In addition to the additional image with the fixed pattern like above, the additional image, in which the position of the pattern is freely changed, may be prepared.

An additional image C1 is the template image with an approximately round fitting frame C2. The photographed image, scaled up or down in accordance with the size of the fitting frame C2, is synthesized into the fitting frame C2. The additional image may have plural fitting frames C2. In this case, the same photographed image may be fitted into the plural fitting frames like the template image for certification pictures, or the different photographed image may be fitted into each fitting frame.

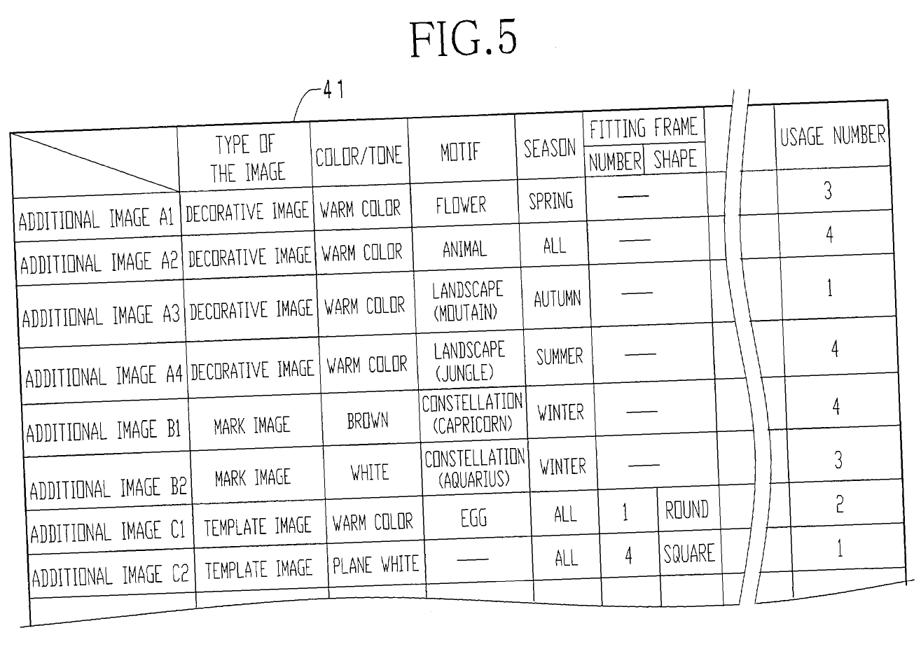

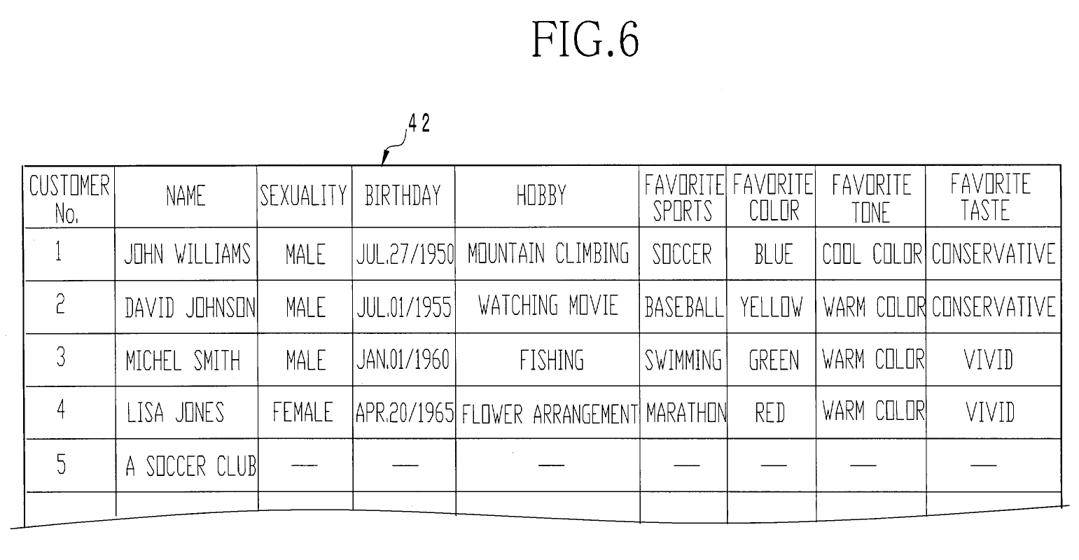

The storage 16 for storing various types of data is provided with a program folder 16a, an additional image folder 16b, and information folder 16c. The program folder 16a has an image synthetic program and an additional image extraction program. The additional image folder 16b has the data of additional images. The information folder 16c has an additional image feature information file 41 (referring to FIG. 5) and a user information file 42 (referring to FIG. 6).

The CPU 26 executes the image synthetic program for operating the synthetic image print system, in order to carry out various types of processing such as read in processing, image synthetic processing and the like. CPU 26 also executes the additional image extraction program, in order to extract the additional images from all of them, on the basis of the extraction criteria.

Referring to FIG. 5, the data of the features of each additional image is recorded on the additional image feature information file 41, with relating to each additional image. The features of each additional image are grouped under items like type of the image, color/tone, motif, season and the like. In a case of the template image, the shape and number of the fitting frames are recorded too. The usage number of each additional image is recorded on the additional image feature information file 41. The usage number, which indicates the popularity of each additional image, is used for determining the displaying order of the additional images on the selection screen. The data of each additional image may include this feature information, instead of providing the additional image feature information file.

Referring to FIG. 6, the profile information of the users is recorded on the user information file 42. The user profile information includes the favorite taste information of the user such as hobby, favorite sports, favorite color and tone, and favorite pattern and the like, in addition to name, sexuality, birthday, address, phone number and the like. The user enters his profile information with his first order. The user profile information is also used as the extraction criteria of the additional image.

The user is not limited to an individual, but may be a group like a corporation, a circle and the like. In this case, the profile information of the group (user No. 5, for example) is entered. In a case of the circle, for example, the type of the circle like a travel circle and a soccer circle is entered as the profile information of the group.

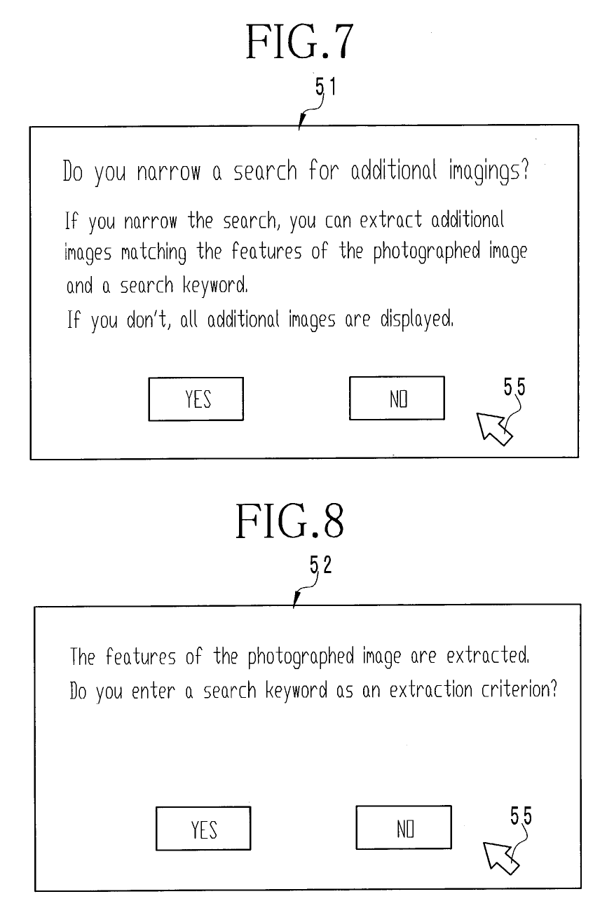

When the photographed image file is read in with following instructions of an operation screen displayed on the display panel 14, an inquiry screen 51 which inquires whether to narrow a search or not, as shown in FIG. 7, is displayed. If the user selects “NO” with the pointer 55 of the mouse 33 in the inquiry screen 51, all additional images contained in the additional image folder 16b are displayed on the display panel 14.

If the user selects “YES” in the inquiry screen 51, the CPU 26 executes the additional image extraction program read from the storage 16. The additional image extraction program analyzes the photographed image file to extract the feature information from the photographed image file which is sent from the input image memory 31 to the image. Upon finishing the analysis, as shown in FIG. 8, an inquiry screen 52 which inquires whether to input a search keyword or not is displayed. If the user selects “NO” in the inquiry screen 52, the feature information of the photographed image file and the profile information of the user are immediately loaded to the RAM 27 as the extraction criteria.

If the user selects “YES” in the inquiry screen 52, a search keyword input screen is displayed. In the input screen, the user can input any search keyword from the keyboard 34. The inputted search keyword is loaded to the RAM 27 as the extraction criteria, in addition to the feature information of the photographed image file and the profile information of the user. Then, the extraction processing of the additional image is carried out on the basis of the extraction criteria with the use of the read out additional image information file 41.

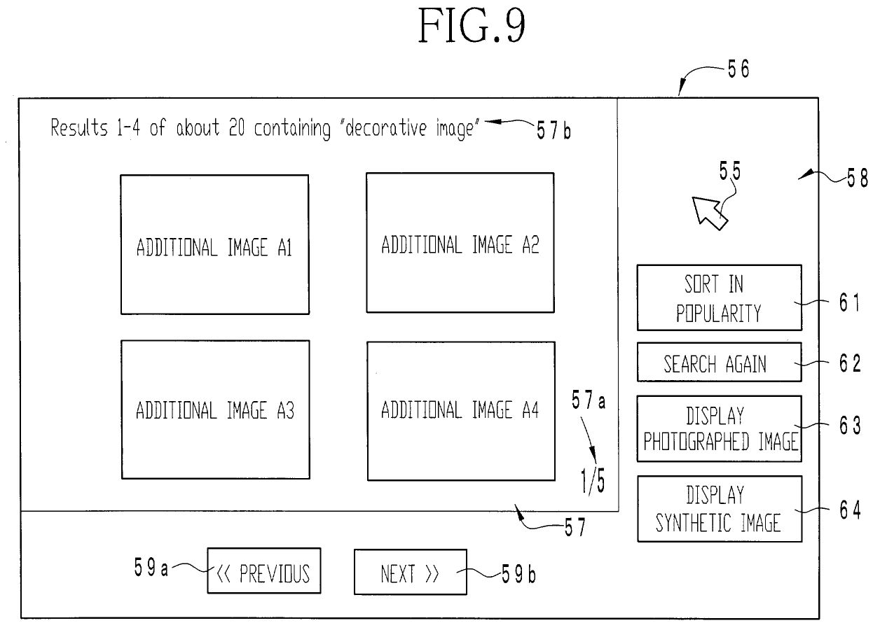

An additional image selection screen 56 has an image display area 57 and an operation area 58. The four additional images A1 to A4 which can be synthesized are displayed at a time on the image display area 57, so that the user selects the additional image with looking at them. On the image display area 57, as shown in FIG. 9, the names of the extracted additional images may be displayed, in addition to the images themselves. In this case, the name of each additional image file corresponds to the feature thereof.

The bottom right of the image display area 57 is marked with a page number 57a. When the search is narrowed, the number 57b of the additional images corresponding with the extraction criteria is marked at the top left of the image display area 57.

The operation area 58 is provided with a “PREVIOUS” button 59a and a “NEXT” button 59b which are used for rolling up and down a page, respectively. The user moves the mouse pointer 55 over the desired additional image, and clicks a mouse button, to select the additional image.

Clicking a “SORT IN POPULARITY” button 61, namely clicking the mouse 33 over the button 61, the additional images are displayed on the display area 57 in order of popularity.

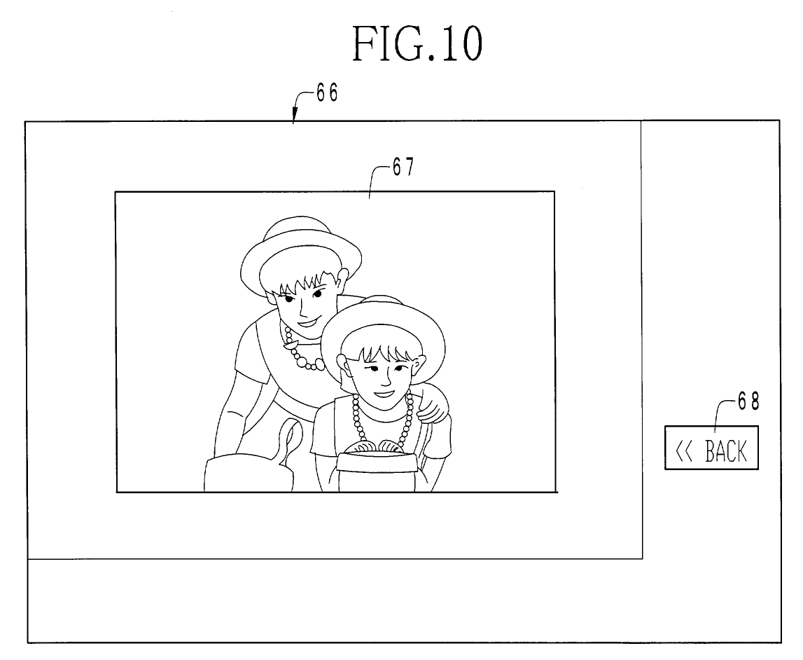

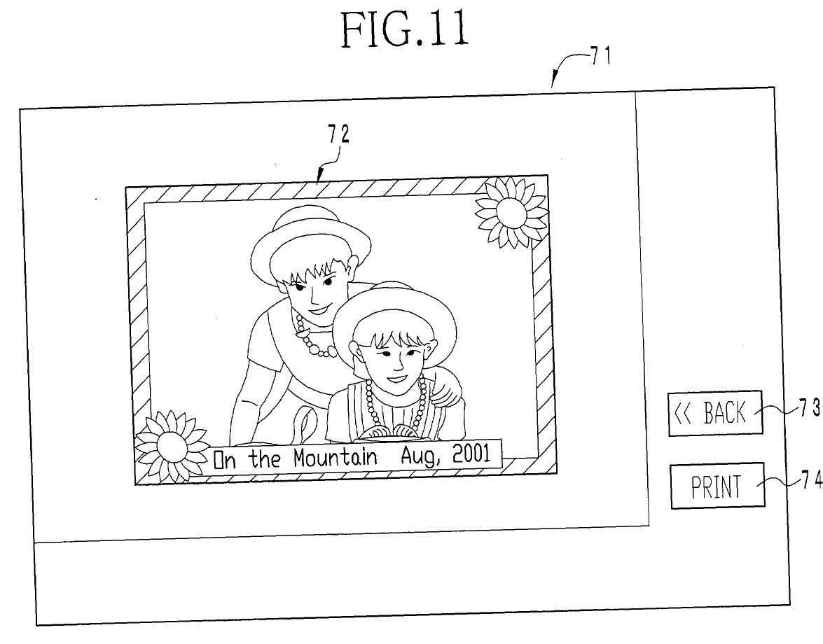

A “SEARCH AGAIN” button 62 is used when the search keyword is re-inputted. Clicking a “DISPLAY PHOTOGRAPHED IMAGE” button shows a photographed image display screen 66 shown in FIG. 10, which displays a photographed image 67. Then, the display panel 14 returns to the additional image selection screen 56 in clicking a “BACK” button 68. When the user clicks a “DISPLAY SYNTHETIC IMAGE” button 64 after indicating the desired additional image, the display panel 14 displays a synthetic image display screen 71 (referring to FIG. 11), which displays a synthetic image 72. If the user clicks a “BACK” button 73 during the display of the synthetic image, the display panel 14 returns to the additional image selection screen 56. If a “PRINT” button 74 is clicked, the additional image 72 is printed.

In the synthetic image print system 10, the additional image extraction apparatus comprises the system controller 11 and the storage 16 which stores the additional image extraction program, the additional image feature information file, the user information file and the like. The system controller 11 is an additional image extraction means for extracting the additional images by means of executing the additional image extraction program.

In a case where the feature information of the photographed image is used as the extraction criteria, the image feature analyzer 19 becomes an extraction criteria input means. In a case where the search keyword is inputted, the command input device 18 becomes the extraction criteria input means. When the feature information of the photographed image is not used as the extraction criteria, the synthetic image print system 10 may not have the image feature analyzer 19.

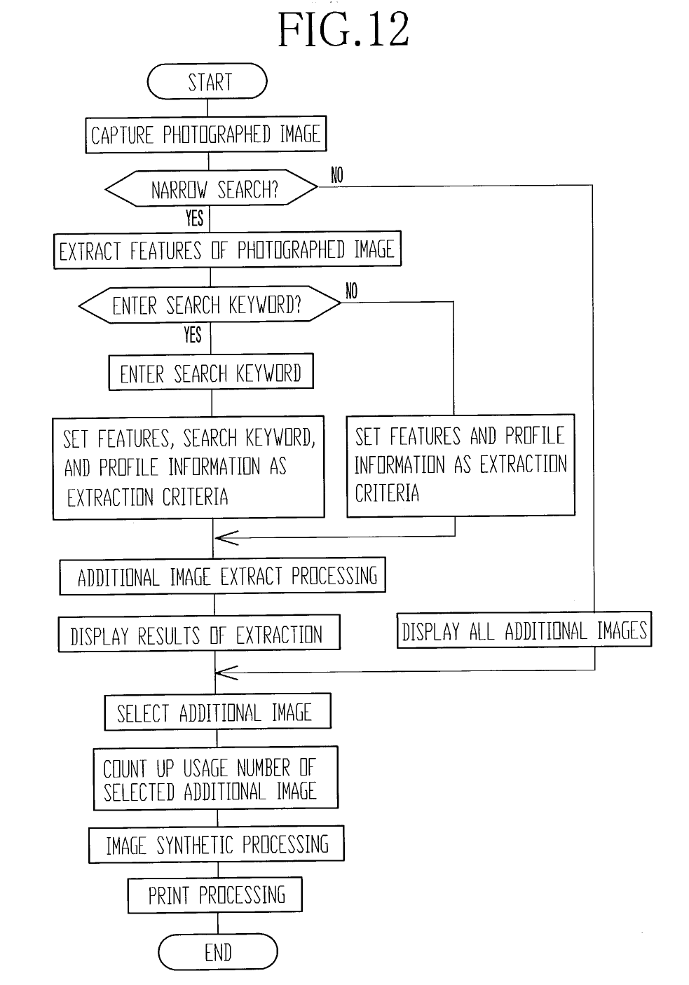

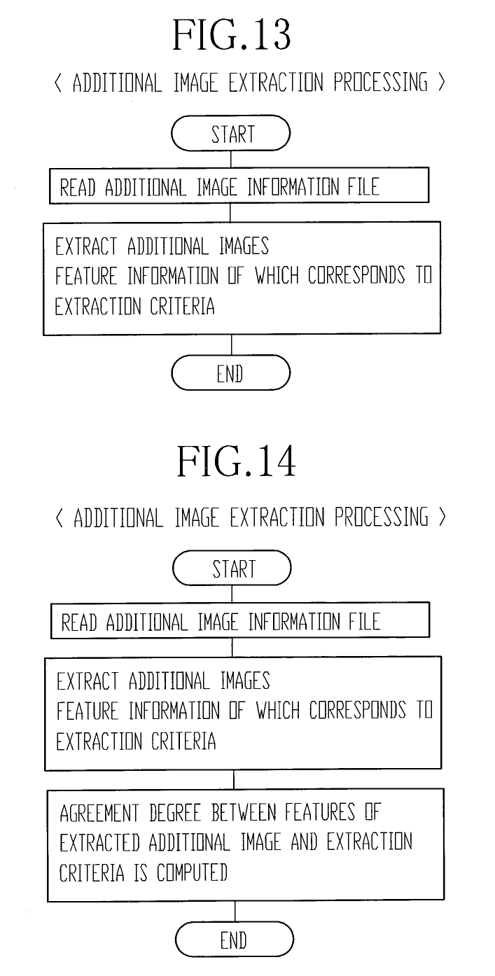

The operation of the synthetic image print system 10 with the above structure will be hereinafter described with referring to flow charts shown in FIGS. 12 and 13. The user selects synthetic image creation service in a menu screen displayed on the display panel 14. The user enters the profile information in his first order. When the user sets the memory card 36 in the file reader 12 with following an instruction displayed on the display panel 14, the photographed image starts to be read.

Upon finishing the read of the photographed image file, the inquiry screen 51 for inquiring whether to narrow the search or not is displayed. If the user selects “NO” on the inquiry screen 51, all additional images stored in the additional image folder 16b are displayed on the additional image selection screen 56. If the user selects “YES”, on the other hand, the image feature analyzer 19 analyzes the photographed image file to extract the features of the photographed image.

Upon finishing the analysis of the photographed image, the inquiry screen 52 which inquires whether to input the search keyword or not is displayed. If the user does not input the search keyword, the feature information of the photographed image and the profile information of the user are set as the extraction criteria. If the user inputs the search keyword, the inputted search keyword is also set as the extraction criteria.

The additional images are extracted on the basis of these extraction criteria. Ina case of narrowing the search, only the extracted additional images are displayed on the additional image selection screen 56. Narrowing the search makes it possible to extract the desired additional images out of a great many additional images. Therefore, it is possible for the user to reduce expense in time and effort to select the desired additional image.

The feature information of the photographed image, and the user profile information including the favorite taste information are used as the extraction criteria. Therefore, it is possible to extract the additional images which are suited for the photographed image and the taste of the user.

The user checks the synthetic image 72 in the synthetic image display screen 71, and clicks the “PRINT” button 74. Then, the synthetic image 72 is printed.

In the additional image extract processing, as shown in FIG. 14, agreement degree between the extraction criteria and the feature information of the additional image may be computed. The agreement degree is determined based on, for example, the number of the features of the additional image which corresponds with the set plural extraction criteria. Taking a case where the two extraction criteria, which are the favorite color of the user and the photographed location information, for example, correspond with the feature information of the additional image, the agreement degree of the additional image is “2”.

Besides simply summing up the number of corresponding extraction criteria, as described above, various computing means of the agreement degree are considerable. Each feature of the additional image has an agreement point, for example. The agreement points of the features corresponding with the extraction criteria may be summed up into the agreement degree. In this means, the additional image with sharp red, for example, has three agreement points. When the extraction criteria includes red, “3”, not simply “1”, is summed up to the agreement degree.

The additional image with the illustration of a succor ball has the high agreement point with succor. In a case where the extraction criteria include the succor, (as the favorite sports of the user, for example), the agreement degree becomes high. Assigning weights to each feature of the additional images like this makes it possible to extract the additional images which are more suited to the set extraction criteria. Accordingly, it is possible for the user to easily select the additional image which is suited to the photographed image, or the taste of the user.

The additional images are displayed in the additional image selection screen 56 in order of declining the agreement degree. Only the additional images having the higher agreement degree than a predetermined reference value may be displayed on the additional image selection screen 56.

As described above, there are additional images with the fixed pattern. In a case of selecting the additional image like this, the pattern may overlap with the important portion of the photographed image. Thus, it is possible to exclude the additional images overlapping with a no-synthetic area which is designated to an important area within the photographed image, in extracting the additional images.

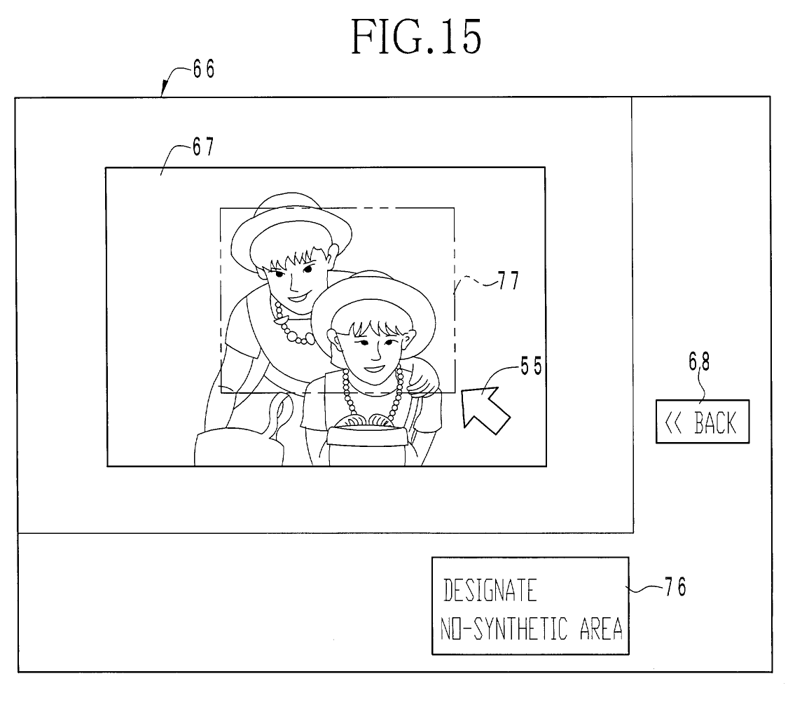

Referring to FIG. 15, the no-synthetic area is designated in the photographed image display screen 66. Upon clicking a “DESIGNATE NO-SYNTHETIC AREA” button 76, a designation frame 77 is displayed inside the photographed image 67. The user operates the pointer 55 of the mouse 33, for example, to vary the size and the position of the designation frame 77. The area enclosed with the designation frame 77 becomes the no-synthetic area.

Information about the no-synthetic area is stored on the RAM 27. In FIG. 15, the faces of persons as a main subject are designated as the no-synthetic area with the designation frame 77. The additional images overlapping with the faces of the persons are excluded in the extraction, so that the faces of the persons do not disappear by the synthesis. It may be possible to designate plural no-synthetic areas. The shape of the designation frame may be a round, besides a rectangle.

The additional image may be an advertisement image including the advertisement of a company. In this case, charge for creating the synthetic image is discounted when the user selects the advertisement image. The company may use the profile information of the users to narrow targets for introducing the advertisement. A company dealing in sports goods, for example, should desire to insert its advertisement into the photographed image of the user whose hobby is sports, in consideration of advertising effectiveness.

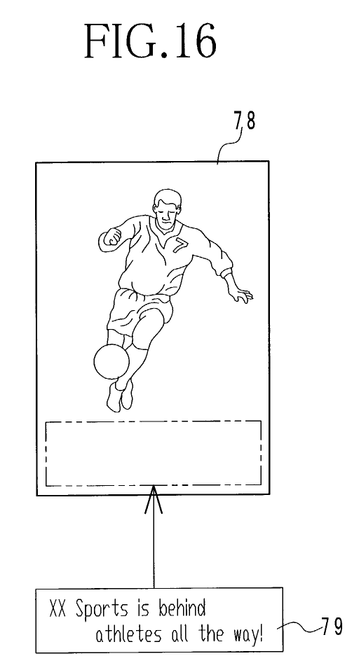

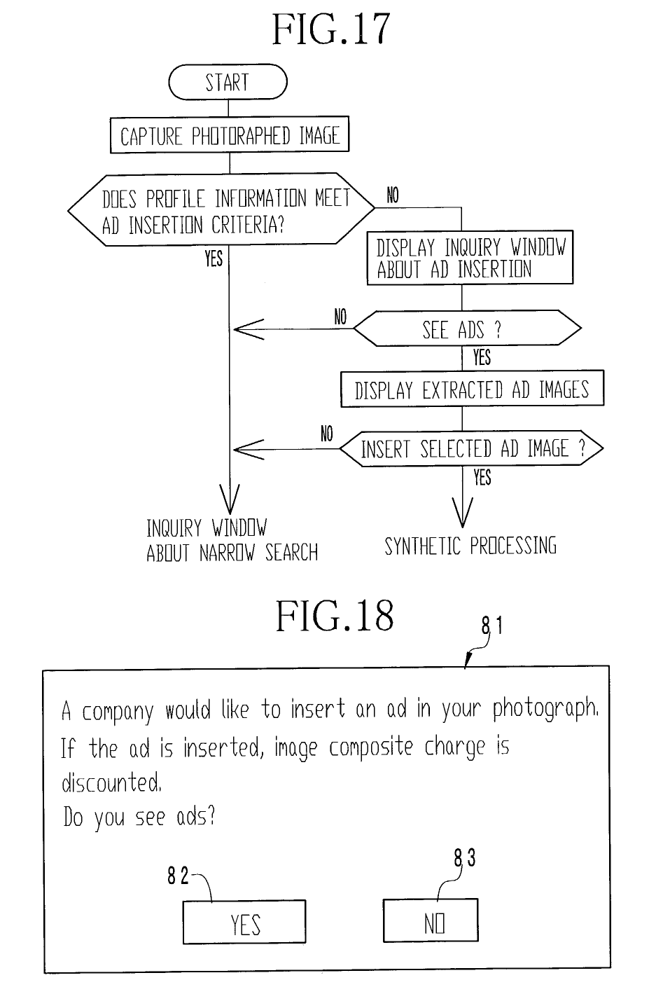

In a case where the user is a soccer club, for example, there should be many photographed images 78 in a scene of a soccer game, as shown in FIG. 16. Synthesizing the advertisement image with the photographed image 78 like this gives the extremely high advertising effectiveness, because the people of the soccer club mainly appreciate the synthetic image.

Accordingly, the synthetic image print system 10 checks a company's requirement stored on the storage 16 in advance, and the profile information of the users. Then, an inquiry screen 81, which inquires whether to allow the insertion of the advertisement or not, may be displayed for the users who meet the company's requirement.

The above company dealing in the sports goods enters the requirement, that is, “the user is a sports hobbyist or a sports club”. The system controller 11 checks the user profile information. When the hobby of the user is sports like soccer or baseball, or the user is a sports circle, the system controller 11 displays the inquiry screen 81.

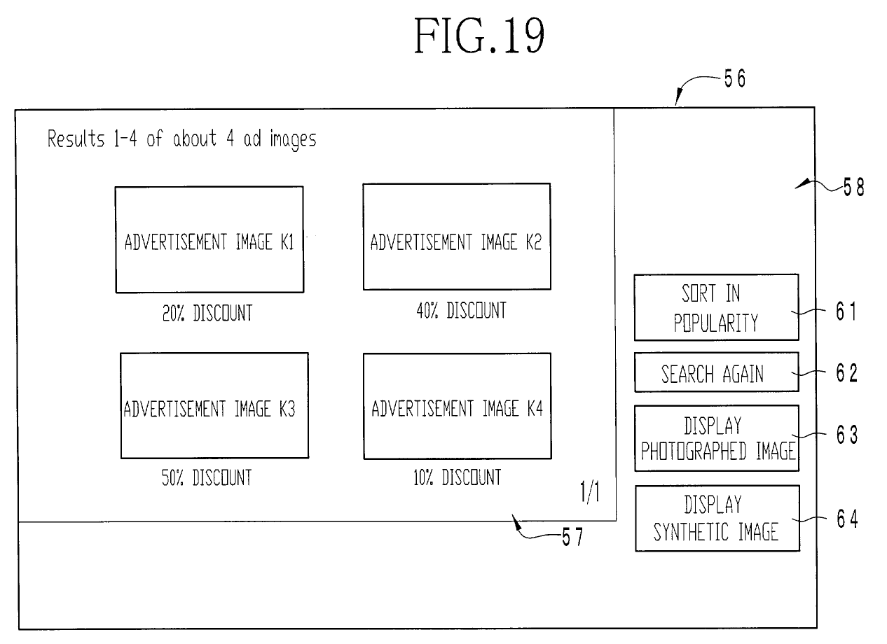

If the user wants to look at the advertisement, the user clicks a “YES” button 82 in the inquiry screen 81. If the user clicks a “NO” button 83, the display panel 14 returns to the usual additional image selection screen 56. Upon clicking the “YES” button 82, the system controller 11 extracts the advertisement images of the company who wants the insertion thereof, and the extracted additional images K1 to K4 are displayed on the additional image selection screen 56 (referring to FIG. 19).

The discount rate to the image synthetic charge is shown under each of the advertisement images K1 to K4. If the advertisement image is inserted, the user receives a discount of the image synthetic charge at the discount rate. The discount rate is determined in consideration of the size, contents, popularity, effectiveness and the like of the advertisement image. The user determines whether to insert the advertisement image in the photographed image or not, in consideration of the advertisement image and the discount rate. When the user does not insert any advertisement image, the user selects a “SEARCH AGAIN” button to re-search the additional images.

In the above embodiment, the company is a profit-making corporation dealing in the sports goods. The company, however, may be various organizations such as a charitable corporation and an association, and an employer, and the like.

In the above embodiment, the additional image extraction apparatus is applied to the synthetic image print system set up in a storefront. The additional image extraction apparatus, however, maybe applied to a synthetic image order device for receiving the order of the synthetic image creation service via the Internet. In this case, the additional image selection screen is sent to the PC of the user via a communication means for connecting the Internet. The user downloads the additional image selection screen to his PC via the Internet, and selects the desired additional image. The photographed image file, the search keyword, and the user profile information are sent to the synthetic image order device through the Internet.

It may be possible for the user to update the own profile information. The synthetic image is printed on a single face of a sheet of paper in the above embodiment, but the synthetic image may be printed on both faces thereof.

In the above embodiment, a vender prepares all additional images in advance, but the photographed image brought by the user may be also entered in the additional image folder as the additional image. If a group photograph is entered as the additional image, for example, it is possible for each member of the group to create the synthetic image from a facial portrait brought by himself and the group photograph. The entry of the additional image like this may be carried out online through the Internet.

In this case, a group name is entered as the feature information of the entered group photograph. Thus, it is possible to easily extract the group photograph by means of inputting the group name as the search keyword. Otherwise, if the photographed image file brought by the member has the group name, the group name is set as the feature information of the photographed image. Therefore, it is possible to extract the group photograph without inputting any search keyword.

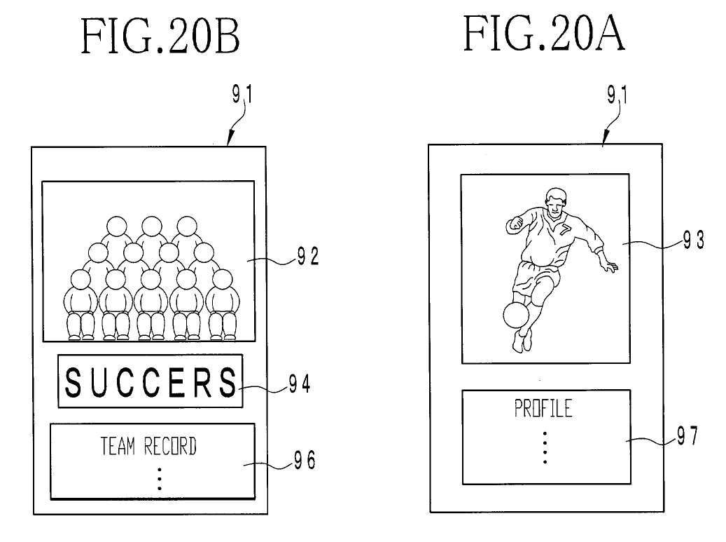

FIGS. 20A and 20B show a membership card 91 of a soccer team. A group photograph 92 is printed in the front face of the membership card 91, and a portrait 93 of each member is printed in the rear face thereof. The logo 94 and the profile information 96 of the team are printed under the group photograph 92. The profile information 97 of the member is printed under the portrait 93.

The logo 94 is entered in advance as the additional image, just as with the group photograph 92. The team is entered in the user information file 42 as the user, and the profile information thereof includes an overall record and the like of the team. Each of the profile information 96 of the team and the profile information 97 of the member may be read out from the user information file 42, or may be inputted from the keyboard 34 in creating the synthetic image.

Entering the team as the user, and updating the profile information thereof at any time make it possible for each member to always print the latest information in the membership card 91. When the profile information 96 of the team is updated, the vender may send e-mail or a postcard in order to promote the order of the print. Accordingly, benefit to sales is expectable. The same goes for a case where the group photograph 92 is updated due to the participation of a new member, or a case where the logo 94 is changed.

It is preferable that the profile information of the team and the profile information of each member are linked with each other. The information of the members belonging to the team is recorded as the profile information of the team, while the information of the team is recorded as the profile information of the member. By doing this, as described above, the members can easily extract the group photograph 92 of the team. Also, the vender can easily inform the update of the team information (the profile information, the group photograph and the like) to each member, when it happens.

The additional image selection screen, the photographed image display screen, the synthetic image display screen, inquiry screens and the like shown in the above embodiment, are just examples of various operation screens, and are not limited to these. The design of the screen, for example, can be properly changed. It is possible to properly change the contents, the displaying order and the like of each screen in accordance with the operation procedures.

Although the present invention has been described with respect to the preferred embodiment, the present invention is not to be limited to the above embodiment but, on the contrary, various modifications will be possible to those skilled in the art without departing from the scope of claims appended hereto.

What is claimed is:

1. An additional image extraction apparatus for extracting at least one additional image synthesized with an input image, said additional image extraction apparatus comprising:
a memory device for storing feature information of plural said additional images in relation to each of said additional images;
a selection device for extracting said additional image related to said feature information corresponding with an extraction criterion; and
a display device for displaying said extracted additional image.

2. An additional image extraction apparatus as recited in claim 1, further comprising:
an image analysis device for analyzing a feature of said input image, said feature of said input image being used as said extract criterion.

3. An additional image extraction apparatus as recited in claim 1, further comprising:
an input device to input an arbitrary search keyword, said search keyword being used as said extraction criterion.

4. An additional image extraction apparatus as recited in claim 1, wherein said memory device stores user profile information used as said extraction criterion.

5. An additional image extraction apparatus as recited in claim 1, wherein said memory device stores a usage number of each of said additional images, and said display device displays a plurality of said extracted additional images in order of declining said usage number.

6. An additional image extraction apparatus as recited in claim 1, further comprising:
an agreement degree calculation device for calculating agreement degree between said feature information of said additional image and said extraction criterion, and said display device displaying a plurality of said extracted additional images in order of declining said agreement degree.

7. An additional image extraction apparatus as recited in claim 1, further comprising:
a designation device for designating an arbitrary area within said input image, said selection device excluding said additional image overlapping with said area designated by said designation device, such that said area is not overlapped with said additional image in said synthetic image.

8. An additional image extraction apparatus as recited in claim 4, wherein said memory device stores advertisement images and synthetic requirement information in relation to each other, said selection device extracts said advertisement image related to said synthetic requirement information corresponding with said user profile information, as said additional image.

9. An additional image extraction apparatus as recited in claim 8, wherein said display device displays a discount rate to a synthetic charge, said synthetic charge is discounted at said discount rate when said advertisement image is synthesized with said input image.

10. An additional image extraction apparatus as recited in claim 1, wherein said input image is a photographed image taken by a digital camera, and each of said photographed image has photograph information used as said extraction criterion.

11. An additional image extraction apparatus for extracting at least one additional image synthesized with an input image, said additional image extraction apparatus comprising:
a memory device for storing feature information of said plural additional images in relation to each of said additional images, said feature information expressing features of said additional images; and
a selection output device for extracting and outputting said additional image related to said feature information corresponding with an extraction criterion.

12. An additional image extraction apparatus as recited in claim 11, further comprising:
an image analysis device for analyzing said input image to obtain feature data, said selection output device using said feature data as said extract criterion.

13. An additional image extraction apparatus as recited in claim 11, further comprising:
an input device for inputting a search keyword, said selection output device using said search keyword as said extraction criterion.

14. An additional image extraction apparatus as recited in claim 11, wherein said memory device stores user profile information, and said selection output device uses said user profile information as said extraction criterion.

15. An additional image extraction apparatus as recited in claim 11, wherein said input image is a photographed image with photograph information taken by a digital camera, and said selection output device uses said photograph information as said extraction criterion.

16. A method for extracting at least one additional image out of plural additional images synthesized with an input image, said method comprising the steps of:
(a) storing feature information of plural said additional images in relation to each of said additional images, and expressing features of said additional images;
(b) extracting said additional image related to said feature information corresponding with an extraction criterion; and
(c) displaying said extracted additional image on a display panel.

17. A method as recited in claim 16, further comprising the steps of:
(d) obtaining feature data by means of analyzing said input image; and
(e) extracting said additional image with the use of said feature data as said extraction criterion.

18. A method as recited in claim 16, further comprising the step of:
(f) extracting said additional image with the use of a search keyword as said extraction criterion, said search keyword being inputted externally.

19. A method as recited in claim 16, further comprising the steps of:
(g) storing user profile information; and
(h) extracting said additional image with the use of said user profile information as said extraction criterion.

20. A method as recited in claim 19, further comprising the steps of:
(i) storing an advertisement image and synthetic requirement information of said advertisement image, in relation to each other; and
(j) extracting said advertisement image as said additional image, said advertisement image related to said synthetic requirement information corresponding with said user profile information.

21. A method as recited in claim 16, further comprising the steps of:
(k) reading in a photographed image as said input image with photograph information taken by a digital camera; and
(l) extracting said additional image with the use of said photograph information as the extraction criterion.

22. A method as recited in claim 16, further comprising the steps of:
(m) recording usage number information of each of said additional images, said usage number information expressing the number of use for synthesizing with said input image; and
(n) displaying said extracted additional images in order of declining said usage number information.

23. A method as recited in claim 16, further comprising the steps of:
(o) calculating agreement degree between said feature information of said additional image and said extraction criterion; and
(p) displaying said extracted additional images in order of declining said agreement degree.
